(19) United States
(12) Patent Application Publication
(10) Pub. No.: US 2013/0338992 A1
(43) Pub. Date: Dec. 19, 2013

(54) METHOD FOR SIMULATING A SYSTEM

(71) Applicants: Guenther WEISS, Kirchberg (DE); Herbert LEUWER, Backnang (DE); Florian REH, Ludwigsburg (DE); Gunnar PIEL, Hemmingen (DE)

(72) Inventors: Guenther WEISS, Kirchberg (DE); Herbert LEUWER, Backnang (DE); Florian REH, Ludwigsburg (DE); Gunnar PIEL, Hemmingen (DE)

(73) Assignee: ROBERT BOSCH GMBH, Stuttgart (DE)

(21) Appl. No.: 13/920,616

(22) Filed: Jun. 18, 2013

(30) Foreign Application Priority Data
Jun. 18, 2012 (DE) 10 2012 210 208.6

(51) Int. Cl. G06F 17/50

(52) U.S. Cl. CPC G06F 17/5009
USPC 703/21

(57) ABSTRACT

A method and a system are provided for simulating a technical system by means of a model. In the method, at least one simulation tool is stored in an application node, and the model, which is executed under real-time conditions, is stored in a simulation node, using one platform.

### CROSS REFERENCE

The present application claims the benefit under 35 U.S.C. §119 of German Patent Application No. DE 102012210208.6 filed on Jun. 18, 2012, which is expressly incorporated herein by reference in its entirety.

### FIELD

The present invention relates to a method for simulating a technical system by means of a model of the system, and to a system for implementing the method.

### BACKGROUND INFORMATION

A procedure for analyzing systems that are too complicated for the theoretical or formula-based treatment is described as a simulation. This is primarily the case when dynamic system behaviors are involved. During the simulation, experiments are carried out on a model in an effort to obtain information about the real system. The terms ‘the system to be simulated’ and ‘a simulator’ as implementation or realization of a simulation model are used in this context. The sequence of the simulation with concrete values is referred to as simulation experiment. The results of this experiment may then be interpreted and transferred to the system to be simulated.

The simulation of an embedded system in an early development phase is also called a model-in-the-loop (MIL). In this case, the modeling of the model-based software development takes place. Embedded systems communicate with their environment and expect regular, plausible sensor signals as input, and then simulate the physical system. For the proper functioning, it is necessary to simulate the environment of the embedded system. If the embedded system then is simulated in a loop together with the environment model, this is called a model-in-the-loop simulation. Current real-time software-in-the-loop simulation requires a PC, on which the tools are running, and a second hardware or PC, on which the software model is implemented.

On the other hand, in non-real-time software-in-the-loop simulations, tools and software models are already able to be executed on one PC platform these days, but the time behavior of the model in this environment does not correspond to reality.

### SUMMARY

In an example method in accordance with the present invention, it is provided that a simulation tool and a model, running in real time, of the system to be simulated are stored on one platform or one PC, the simulation tool accessing the model during the simulation. The fact that the model runs in real time means that the time behavior of the model corresponds to the time behavior of the system to be simulated. Using one processor, which typically includes multiple arithmetic units or CPUs, processing of the model and simulation tools takes place.

Two operating systems are typically employed in this context. For example, QNX is used as operating system for the model, and an address range is accessed by means of an address management both by the tools and the model. Another conventional operating system without real-time capability may be used for the simulation tool.

In one development, tools and the simulation are therefore running in parallel on one PC platform, the simulation running in real time. This is made possible by using a real-time hypervisor, which partitions the PC platform in such a way that, from the viewpoint of the tool and the model, each node, i.e., simulation node and application node, sees only part of the hardware platform. This also prevents that the application and simulation nodes influence each other, which in turn ensures the real time.

The hypervisor, with whose aid the entire platform is configured, ensures that no conflicts arise from the competition between tools and model to which different CPUs are assigned. This makes the real-time simulation possible.

A hypervisor, also known as virtual machine monitor, is visualization software which creates an environment for virtual machines. In particular, the hypervisor, in this case typically a real-time hypervisor, is a component which has important knowledge of the architecture of the processor of the platform. It checks the hardware assignments to operating systems, protective mechanisms for operating systems, and defines the run-up or boot concept. It should be active only during the configuration of the computer platform and not during the execution, in this case, during the simulation.

The main tasks of the hypervisor consist of generating the runtime environments for the application or the application node and the simulation node in the hypervisor configuration. As a minimum, the runtime environment for a node includes: one or more CPU core processor(s), which is/are assigned to a single node, the core processor never being used by two components jointly;

a memory that is not visible to the other node;

network interfaces that are assigned to a single node;

direct interrupt routing without involving an intermediate layer;

thread scheduling, which is assigned to nodes and is independent thereof;

a real time clock assigned to the nodes;

a time input for the application node;

time signs (time ticks) for the simulation node;

a virtual network interface for the jointly used memory, this interface being realized by means of the memory;

protection of the simulation node from faults of the application node.

The example method, especially in some of its implementations, has considerable advantages. For instance, tools and the software model are able to run on the same platform. The model runs in real time and thus offers the greatest possible real-time reference. Tools and models in this setup are able to be operated simultaneously without affecting each other. This provides considerable cost and handling savings since a second special device with real-time capabilities is dispensed with.

Furthermore, reduced development times result since there is no need to develop a second electronic device. Instead, a conventional PC or a notebook is used. In addition, it should be noted that the computation power automatically grows with the PC development.

Additional advantages and developments of the present invention are described below and are shown in the figures.

It is understood that the features mentioned above and others discussed below are usable not only in the individually stated combination but in other combinations as well, or on their own, without leaving the scope of the present invention.

### BRIEF DESCRIPTION OF THE DRAWINGS

FIG. 1 shows a system according to the related art.

FIG. 2 shows another system according to the related art.

FIG. 3 shows a development of the proposed system.

### DETAILED DESCRIPTION OF EXAMPLE EMBODIMENTS

The present invention is shown schematically in FIG. 3 using exemplary embodiments and will be described in greater detail in the following text with reference to the figures.

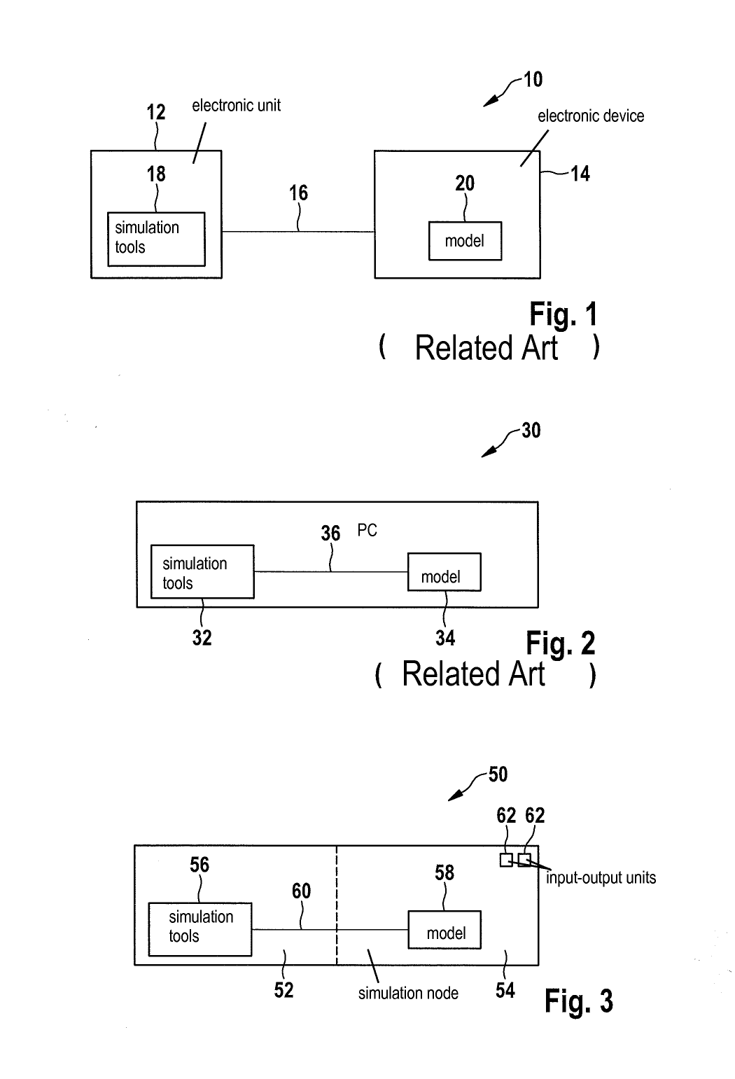

FIG. 1 illustrates a conventional system, which is denoted by reference numeral 10 as a whole. It includes an electronic unit 12 or a PC without real-time capability, and an electronic device 14 which is able to operate in real time. A connection 16 that allows communication is provided between electronic unit 12 and electronic device 14.

Simulation tools 18 are stored in electronic unit 12. Electronic device 14 contains a model 20, which represents a system to be simulated. A simulation of model 20 in real time is made possible via connection 16. However, it should be noted that system 10 shown in FIG. 1 requires two platforms, i.e., electronic unit 12 and electronic device 14. This means that in system 10, a real-time software-in-the-loop simulation requires an electronic unit such as a PC, on which the tools are running, and a second hardware such as a second PC, on which the software model is executed.

FIG. 2 shows another conventional system, which is denoted by reference numeral 30. In this case, it is a PC unable to operate in real time, on which simulation tools 32 and the model 34 are stored, which communicate via a connection 36.

A software-in-the-loop simulation not operating in real time is able to use this system 30, in which tools 32 and the model are executed on one PC platform. The time behavior of model 34 does not represent reality in this environment, so that the simulation is not carried out in real time.

FIG. 3 shows one development of described system 50 in heavily simplified, schematic form. This system 50, for example, is a PC, on which a real-time operating system is implemented and which includes multiple CPUs.

The system is shown in two parts, with an application node 52 without real-time capability, and a real-time-capable simulation node 54. Application node 52 includes at least one simulation tool 56, usually multiple simulation tools 56. A model 58, which was set up using simulation tool 56, for example, is stored in simulation node 54. The communication between the two nodes 52 and 54 takes place via a connection 60.

Input-output units 62 represent interfaces for the connection of external units. The external communication takes place via the PCI bus, for instance.

What is claimed is:

1. A method for simulating a technical system using a model of the system, in which at least one simulation tool is stored in an application node and the model is stored in a simulation node on one platform, the method comprising:
accessing, by the simulation tool, the model to perform the simulation;
wherein the platform is partitioned using a hypervisor, and the method being executed in real time.

2. The method as recited in claim 1, wherein the model is prepared using the at least one simulation tool.

3. The method as recited in claim 1, wherein an external communication is carried out via input-output units.

4. The method as recited in claim 1, wherein the application node and the simulation node access a shared address range.

5. A system for simulating a technical system using a model of the system, comprising:
a platform on which at least one simulation tool and the model are stored; and
a hypervisor, by which the platform is partitioned, stored on the platform.

6. The system as recited in claim 5, further comprising:
input-output units.

7. The system as recited in claim 5, wherein the platform includes a processor having a plurality of arithmetic units.

8. The system as recited in claim 5, wherein the platform is a PC.
